(19) United States
(12) Patent Application Publication
(10) Pub. No.: US 2026/0281333 A1
(43) Pub. Date: Sep. 17, 2026

(54) METHODS AND APPARATUS OF SIGNALLING FOR LOCAL ILLUMINATION COMPENSATION

(71) Applicant: MEDIATEK INC., Hsinchu City (TW)

(72) Inventors: Chih-Hsuan LO, Hsinchu City (TW); Chen-Yen LAI, Hsinchu City (TW); Chia-Ming TSAI, Hsinchu City (TW); Cheng-Yen CHUANG, Hsinchu City (TW); Tzu-Der CHUANG, Hsinchu City (TW); Ching-Yeh CHEN, Hsinchu City (TW); Chih-Wei HSU, Hsinchu City (TW); Yi-Wen CHEN, San Jose, CA (US)

(21) Appl. No.: 19/472,696

(22) PCT Filed: Oct. 14, 2024
(86) PCT No.: PCT/CN2024/124664

§ 371 Date: Oct. 5, 2025

Related U.S. Application Data
(60) Provisional application No. 63/590,481, filed on Oct. 16, 2023.
(60) Provisional application No. 63/590,789, filed on Oct. 17, 2023.

(51) Int. Cl. H04N 19/117; H04N 19/176

(52) U.S. Cl. CPC H04N 19/117; H04N 19/176

(57) ABSTRACT

A method and apparatus for video coding are disclosed. According to this method, a first flag to indicate whether to apply LIC (Local Illumination Compensation) process for a candidate is determined. A second flag to indicate whether the first flag is correct or not is determined. The current block is encoded or decoded by using coding information comprising LIC prediction generated by applying the LIC process to a target candidate according to the first flag and the second flag. According to this method, for a current block coded in bilateral matching AMVP-merge mode, an explicit LIC flag is signalled at the encoder side or parsed at the decoder side. The current block is encoded or decoded by using coding information comprising LIC prediction generated by applying LIC process to a selected merge candidate and/or a selected AMVP candidate according to the explicit LIC flag.

### CROSS REFERENCE TO RELATED APPLICATIONS

The present invention is a non-Provisional Application of and claims priority to U.S. Provisional Patent Application No. 63/590,481, filed on Oct. 16, 2023 and U.S. Provisional Patent Application No. 63/590,789, filed on Oct. 17, 2023. The U.S. Provisional Patent Applications are hereby incorporated by reference in their entireties.

### FIELD OF THE INVENTION

The present invention relates to video coding system. In particular, the present invention relates to signalling LIC flag for a video coding system incorporating the LIC coding tool.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Decoder Side Intra Mode Derivation (DIMD)

When DIMD is applied, two intra modes are derived from the reconstructed neighbor samples, and those two predictors are combined with the planar mode predictor with the weights derived from the gradients as described in JVET-00449. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx << 4 ) >> x ) \& 15$$

$$x + = ( 3 + ( normDiff ! = 0 ) ? 1 : 0 )$$

$$Orient = ( Gy * ( DivSigTable [ normDiff ] \vert 8 ) + ( 1 << ( x - 1 ) ) ) >> x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighbouring blocks.

### DIMD Chroma Mode

The DIMD chroma mode uses the DIMD derivation method to derive the chroma intra prediction mode of the current block based on the neighbouring reconstructed Y, Cb and Cr samples in the second neighbouring row and column as shown in FIG. 2. In FIG. 2, areas 210, 220 and 230 correspond to collocated Y block, current Cb block and current Cr block. The circles outside areas 210, 220 and 230 correspond to respective neighbouring reconstructed samples. The grey circles represent the sample locations where the gradients are determined for DIMD. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signalled to indicate whether the proposed DIMD chroma mode is applied. The best N derived DIMD modes in terms of the histogram amplitudes are then blended to form a final predictor for the current block.

### Fusion for Template-Based Intra Mode Derivation (TIMD)

For each intra prediction mode in MPMs, the SATD between the prediction and reconstruction samples of the template is calculated. Normally, the left and above neighbouring reconstructed samples are used as the template. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold. In the test, the cost factor of 2 is applied as follows:

$$costMode 2 < 2 * costMode 1.$$

If this condition is true, the fusion is applied, otherwise the only model is used. Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

### Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
1) For angular intra prediction modes including the single mode case of TIMD and DIMD, the method derives intra prediction by weighting intra predictions obtained from multiple reference lines represented as p_{fusion}=w₀pₗᵢₙₑ+w₁pₗᵢₙₑ+1, where pₗᵢₙₑ is the intra prediction from the default reference line and pₗᵢₙₑ+1 is the prediction from the line above the default reference line. The weights are set as w₀=3/4 and w₁=1/4.
2) For TIMD mode with blending, pₗᵢₙₑ is used for the first mode (w₀=1, w₁=0) and pₗᵢₙₑ+1 is used for the second mode (w₀=0, w₁=1).
3) For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16. It is used with MRL and not applied for ISP coded blocks. In one method, PDPC is applied for the intra prediction mode using the closest to the current block reference line.

### Multi-Model LM (MMLM)

CCLM included in VVC is extended by adding three Multi-model LM (MMLM) modes (JVET-D0110). In each MMLM mode, the reconstructed neighbouring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### Slope Adjustment of CCLM

CCLM uses a model with 2 parameters to map luma values to chroma values as shown in FIG. 3A. The slope parameter “a” and the bias parameter “b” define the mapping as follows:

$$chromaVal = a * lumaVal + b$$

An adjustment “u” to the slope parameter is signalled to update the model to the following form, as shown in FIG. 3B:

$$chromaVal = {a}^{′} * lumaVal + {b}^{′}$$

$$where$$

$${a}^{′} = a + u ,$$

$${b}^{′} = b - u * {y}_{r} .$$

With this selection, the mapping function is tilted or rotated around the point with luminance value yr. The average of the reference luma samples used in the model creation as yr in order to provide a meaningful modification to the model. FIG. 3A and FIG. 3B illustrates the process.

### Convolutional Cross-Component Model (CCCM)

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Convolutional Filter of CCCM

The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as shown in FIG. 4.

The nonlinear term (denoted as P) is represented as power of two of the centre luma sample C and scaled to the sample value range of the content:

$$P = ( C * C + midVal ) >> bitDepth .$$

For example, for 10-bit contents, the nonlinear term is calculated as:

$$P = ( C * C + 5 \; 12 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### Calculation of Filter Coefficients of CCCM

The filter coefficients ci are calculated by minimising MSE between predicted and reconstructed chroma samples in the reference area. FIG. 5 illustrates the reference area which consists of 2 or 6 lines of chroma samples above and left of the PU. Whether to use 6 lines or 2 lines of neighbouring samples to derive the CCCM model parameters in the single model CCCM is determined by a template cost. Similarly, for the multi-model CCCM mode, the two candidates use 6 lines neighbouring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operations during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 << ( bitDepth - 1 )$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operations are replaced with multiplication (with a scale factor) and shift operation, where a scale factor and a number of shifts are calculated based on denominator similar to the method used in calculation of CCLM parameters.

### CCCM Signalling

Usage of the mode is signalled with a CABAC coded PU level flag. One new CABAC context is included to support this. When it comes to signalling, CCCM is considered a sub-mode of CCLM. That is, the CCCM flag is only signalled if intra prediction mode is LM_CHROMA.

### Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled to the current CU, one flag is signalled to indicate whether GLM is enabled for both Cb and Cr components; if the GLM is enabled, another flag is signalled to indicate which of the two GLM modes is selected and one syntax element is further signalled to select one of 4 gradient filters (as shown in FIG. 6) for the gradient calculation.

CCCM using Non-Downsampled Luma Samples (NS-CCCM)

CCCM mode with 3×2 filter using non-downsampled luma samples is used, which consists of 6-tap spatial terms, four nonlinear terms and a bias term. The 6-tap spatial terms correspond to 6 neighbouring luma samples (i.e., L₀, L₁, . . . , L₅) around the chroma sample (i.e., C) to be predicted, the four non-linear terms are derived from the samples L₀, L₁, L₂, and L₃ as shown in FIG. 7.

$$C = {\sum }_{i = 0}^{5} {α}_{i} \cdot ( {L}_{i} - offsetLuma ) + {\sum }_{i = 6}^{9} {α}_{i} ( ( {( {L}_{i - 4} - offsetLuma )}^{2} + β ) ≫ bitDepth ) + {α}_{10} \cdot β + offsetChroma$$

where αᵢ is the coefficient, and β is the offset. Same to the existing CCCM design, up to 6 lines/columns of chroma samples above and left to the current CU are applied to derive the filter coefficients. The filter coefficients are derived based on the same LDL decomposition method used in CCCM. The proposed method is signalled as an additional CCCM model besides the existing one. When the CCCM is selected, one single flag is signalled and used for both chroma components to indicate whether the default CCCM model or the proposed CCCM model is applied. Additionally, SPS signalling is introduced to indicate whether the CCCM using non-downsampled luma samples is enabled.

### Gradient and Location Based Convolutional Cross-Component Model (GL-CCCM)

This method maps luma values into chroma values using a filter with inputs consisting of one spatial luma sample, two gradient values, two location information, a nonlinear term, and a bias term. The GL-CCCM method uses gradient and location information instead of the 4 spatial neighbour samples used in the CCCM filter. The GL-CCCM filter used for the prediction is:

$$predCrhomaVal = {c}_{0} C + {c}_{1} {G}_{y} + {c}_{2} {G}_{x} + {c}_{3} Y + {c}_{4} X + {c}_{5} P + {c}_{6} B$$

where G_{y} and Gₓ are the vertical and horizontal gradients, respectively, and are calculated as FIG. 8:

$${G}_{y} = ( 2 N + N W + N E ) - ( 2 S + S W + SE )$$

$${G}_{x} = ( 2 W + N W + S W ) - ( 2 E + NE + SE )$$

Moreover, the Y and X are the spatial coordinates of the centre luma sample. The rest of the parameters are the same as CCCM tool. The reference area for the parameter calculation is the same as CCCM method.

The usage of the mode is signalled with a CABAC coded PU level flag. When it comes to signalling, GL-CCCM is considered a sub-mode of CCCM. That is, the GL-CCCM flag is only signalled if original CCCM flag is true.

Similar to the CCCM, GL-CCCM tool has 6 modes for calculating the parameters:
Single-model GL-CCCM from above and left templates
Single-model GL-CCCM from above template
Single-model GL-CCCM from left template
Multi-model GL-CCCM from above and left templates
Multi-model GL-CCCM from above template
Multi-model GL-CCCM from left template

The encoder performs SATD search for the 6 GL-CCCM modes along with the existing CCCM modes to find the best candidates for full RD tests.

CCCM with Multiple Downsampling Filters (MDF-CCCM)

Multiple downsampling filters are applied to a group of reconstructed luma samples in a CCCM. The linear combination of these downsampled reconstructed samples is multiplied by derived filter coefficients to form the final chroma predictor. The horizontal or vertical location of the centre luma sample are also considered in the tested model. The cross-component models shown below are tested as additional CCCM modes with a mode index signalled in the bitstream:

$$Model 1 : predChroma = c 0 * H ( C ) + c 1 * G 1 ( C ) + c 2 * G 2 ( C ) + c 3 * G 3 ( C ) + c 4 * P ( H ( C ) ) + c 5 * P ( G 1 ( C ) ) + c 6 * P ( G 2 ( C ) ) + c 7 * X + c 8 * Y + c 9 * B \qquad ( 1 )$$

$$Model 2 : predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * P ( H ( C ) ) + c 7 * P ( H ( W ) ) + c 8 * P ( H ( E ) ) + c 9 * X + c 10 * B \qquad ( 2 )$$

$$Model 3 : predChroma = c 0 * H ( C ) + c 1 * H ( N E ) + c 2 * H ( S W ) + c 3 * G 3 ( C ) + c 4 * G 3 ( NE ) + c 5 * G 3 ( SW ) + c 6 * P ( H ( C ) ) + c 7 * P ( H ( N E ) ) + c 8 * P ( H ( S W ) ) + c 9 * Y + c 10 * B \qquad ( 3 )$$

where H(⋅) 910, G1(⋅) 920, G2(⋅) 930, G3(⋅) 940 are various downsampling filters as indicated in FIG. 9, C denotes the current chroma sample position, and N, S, W, E, NE, SW are the positions around C, ci are filter coefficients, P and B are nonlinear term and bias term, and X and Y are the horizontal and vertical locations of the centre luma sample with respect to the top-left coordinate of the block.

### Local-Boosting Cross-Component Prediction (LB-CCP)

Prediction samples of MM-CCLM/MM-CCCM can be filtered with neighbouring samples. As shown in FIG. 10, a 3×3 low-pass filter is applied to filter prediction samples generated by MM-CCLM/MM-CCCM. For a sample at a top/left boundary, the filtering window may involve neighbouring reconstructed samples. For inner samples, the filtering window only involves prediction samples, which may be padded. A flag is signalled to indicate whether filtering is applied or not for a block coded with MM-CCLM/MM-CCCM.

### Cross-Component Prediction (CCP) Merge (a.k.a., Non-Local CCP) Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. A CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/8}}. The offset parameter is derived according to the default scaling parameter, average neighbouring reconstructed luma sample value, and average neighbouring reconstructed Cb/Cr sample value.

A flag is signalled to indicate whether the CCP merge mode is applied or not. If CCP merge mode is applied, an index is signalled to indicate which candidate model is used by the current block. In addition, CCP merge mode is not allowed for the current chroma coding block when the current CU is coded by Intra Sub-Partitions (ISP) with single tree, or the current chroma coding block size is less than or equal to 16.

### Local Illumination Compensation (LIC)

LIC is an inter prediction technique to model local illumination variation between the current block and its prediction block as a function of that between the current block template and the reference block template. The parameters of the function can be denoted by a scale a and an offset β, which forms a linear equation, that is, α*p[x]+8 to compensate illumination changes, where p[x] is a reference sample pointed to by MV at a location x on reference picture. When wrap around motion compensation is enabled, the MV shall be clipped with wrap around offset taken into consideration. Since α and β can be derived based on the current block template and the reference block template, no signalling overhead is required for them, except that an LIC flag is signalled for AMVP mode to indicate the use of LIC.

The local illumination compensation proposed in JVET-00066 is used for uni-prediction inter CUs with the following modifications.
Intra neighbour samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### Bi-Predictive LIC

In the method, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ] ,$$

$$and$$

$${p}_{0}^{′} [ x , y ] = {α}_{0} \cdot {P}_{0} [ x , y ] + {β}_{0} ,$$

$${p}_{1}^{′} [ x , y ] = {α}_{1} \cdot {P}_{1} [ x , y ] + {β}_{1} ,$$

where α₀ and β₀, and α₁ and β₁ indicate the scales and the offsets in L0 and L1, respectively; ω indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signalled for AMVP bi-predicted CUs for the indication of the LIC mode while the flag is inherited for merge related inter CUs. Additionally, the LIC is disabled when Decoder-Side Motion Vector Refinement (DMVR) (including multi-pass DMVR, adaptive DMVR and affine DMVR) and bi-directional optical flow (BDOF) is applied.

OBMC with LIC

In the method, the OBMC is enabled for the inter blocks that are coded with the LIC mode. To reduce the complexity, the OBMC is only applied to the top and left CU boundaries while being always disabled for the boundaries of the internal sub-blocks of one LIC CU. Additionally, when one neighbouring block is coded with the LIC, its LIC parameters are applied to generate the corresponding prediction samples for the OBMC of one current block.

LIC Flag Determined by TM cost Proposed in JVET-AF0128

In JVET-AF0128 (EE2-3.2), it is proposed to derive the LIC flag of a merge candidate based on template costs.

The LIC flag of a merge candidate is derived by comparing two template costs: a SAD-based template cost, denoted as C0, and a Mean Removal SAD (MRSAD)-based template cost, denoted as C1. The LIC flag is set to be false, if C0<=C1 and is set to be true, if C0>C1.

To favour the inherited LIC flag, C0 is multiplied by α if the inherited LIC flag is false while C1 is multiplied by a if the inherited LIC flag is true, where α<1.

### Bilateral Matching AMVP-Merge Mode and LIC Process

The bi-directional predictor is composed of an AMVP predictor in one direction and a merge predictor in the other direction. The mode can be enabled for a coding block when the selected merge predictor and the AMVP predictor satisfy DMVR condition, where there is at least one reference picture from the past and one reference picture from the future relatively to the current picture and the distances from the two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signalled as a regular uni-directional AMVP, i.e. reference index and MVD are signalled, and it has a derived MVP index if template matching is used or MVP index is signalled when template matching is disabled.

For AMVP direction LX, where X can be 0 or 1, the merge part in the other direction (1−LX) is implicitly derived by minimizing the bilateral matching cost between the AMVP predictor and a merge predictor, i.e., for a pair of the AMVP and a merge motion vectors. For every merge candidate in the merge candidate list which has that other direction (1−LX) motion vector, the bilateral matching cost is calculated by using the merge candidate MV and the AMVP MV. The merge candidate with the smallest cost is selected. The bilateral matching refinement is applied to the coding block with the selected merge candidate MV and the AMVP MV as a starting point.

The mode is indicated by a flag. If the mode is enabled, AMVP direction LX is further indicated by a flag.

When AMVP-merge mode is used for the current block and template matching is enabled, MVD is not signalled. An additional pair of AMVP-merge MVPs is introduced. The merge candidate list is sorted based on the bilateral matching cost in an increase order. An index (0 or 1) is signalled to indicate which merge candidate in the sorted merge candidate list to use. When there is only one candidate in the merge candidate list, the pair of AMVP MVP and merge MVP without bilateral matching MV refinement is padded.

For AMVP-merge mode, the LIC flag used to indicate whether the LIC is enabled for the current block or not is inherited from the merge candidate of the AMVP-merge pair. This LIC flag is referred as an inherited LIC flag.

In order to improve the coding performance for a system using LIC coding tool, methods and apparatus of LIC flag signalling are disclosed.

### BRIEF SUMMARY OF THE INVENTION

A method and apparatus for video coding are disclosed. According to this method, input data associated with a current block is received, wherein the input data comprises pixel data to be encoded at an encoder side or data associated with the current block to be decoded at a decoder side. A first flag to indicate whether to apply LIC (Local Illumination Compensation) process for a candidate is determined. A second flag to indicate whether the first flag is correct or not is determined. The current block is encoded or decoded by using coding information comprising LIC prediction generated by applying the LIC process to a target candidate according to the first flag and the second flag.

In one embodiment, when the second flag is true, the LIC process is applied if the first flag is true and the LIC process is not applied if the first flag is false. In one embodiment, when the second flag is false, the LIC process is not applied if the first flag is true and the LIC process is applied if the first flag is false.

In one embodiment, the second flag is coded by one or more context coded bins. In one embodiment, the second flag is coded by using one or more context variables. In one embodiment, selection of said one or more context variables is dependent on whether the LIC process is on or off for one or more neighbouring blocks.

According to another method, input data associated with a current block is received, wherein the input data comprises pixel data to be encoded at an encoder side or data associated with the current block to be decoded at a decoder side, wherein the current block is coded in bilateral matching AMVP (Advanced Motion Vector Prediction)-merge mode. An explicit LIC (Local Illumination Compensation) flag is signalled at the encoder side or parsed at the decoder side. The current block is encoded or decoded by using coding information comprising LIC prediction generated by applying LIC process to a selected merge candidate and/or a selected AMVP candidate associated with the bilateral matching AMVP-merge mode according to the explicit LIC flag.

In one embodiment, when an inherited LIC flag from a selected merge candidate is true, the LIC process is applied if the explicit LIC flag is set to true and the LIC process is not applied if the explicit LIC flag is set to false. In one embodiment, when an inherited LIC flag from a selected merge candidate is false, the LIC process is applied if the explicit LIC flag is set to false and the LIC process is not applied if the explicit LIC flag is set to true.

In one embodiment, the explicit LIC flag is coded by one or more context coded bins. In one embodiment, the explicit LIC flag is coded by using one or more context variables. In one embodiment, selection of said one or more context variables is dependent on whether the LIC process is on or off for one or more neighbouring blocks.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates neighbouring reconstructed Y, Cb and Cr samples used to derive the gradient for DIMD.

FIG. 3A illustrates an example of the CCLM model.

FIG. 3B illustrates an example of the effect of the slope adjustment parameter “u” for model update.

FIG. 4 illustrates an example of spatial part of the convolutional filter.

FIG. 5 illustrates an example of reference area with paddings used to derive the filter coefficients.

FIG. 6 illustrates an example of Sobel filters to derive the gradient information of the collocated luma sample for the target chroma.

FIG. 7 illustrates the 6-tap spatial terms corresponding to 6 neighbouring luma samples (i.e., L₀, L₁, . . . , L₅) around the chroma sample (i.e., C) to be predicted for CCCM mode.

FIG. 8 illustrates the current chroma sample position C, and N, S, W, E, NE, SW are the down-sampled luma positions around C.

FIG. 9 illustrates filters H(⋅), G1(⋅), G2(⋅), and G3(⋅) used by Multiple Downsampling Filters (MDF) for cross-component modes.

FIG. 10 illustrates an example of filter on samples of MM-CCLM/MM-CCCM.

FIG. 11 illustrates an example of neighbouring templates for calculating model error.

FIG. 12 illustrates a flowchart of an exemplary video coding system that uses a second LIC flag to indicate whether to use the first LIC flag according to an embodiment of the present invention.

FIG. 13 illustrates a flowchart of an exemplary video coding system that uses an explicit LIC flag to indicate whether to apply the LIC process for an AMVP-merge coded block according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance for video coding systems incorporating the LIC coding tool, signalling techniques related to the LIC process are disclosed.

### LIC for Merge Mode

In one embodiment, a second flag can be signalled to indicate the first derived LIC flag of a merge candidate is correct or not. In that, the first derived LIC flag is derived based on template costs. If SAD-based template cost<=a Mean Removal SAD (MRSAD)-based template cost, set the first derived LIC flag to false. If SAD-based template cost>a Mean Removal SAD (MRSAD)-based template cost, set the first derived LIC flag to true.

For example, if SAD-based template cost<=a Mean Removal SAD (MRSAD)-based template cost, the first derived LIC flag will be false and the second signalled flag is true. In this case, LIC will not be used for the current CU.

For another example, if SAD-based template cost<=a Mean Removal SAD (MRSAD)-based template cost, the first derived LIC flag will be false and the second signalled flag is false. In this case, LIC will be used for the current CU.

For another example, if SAD-based template cost>a Mean Removal SAD (MRSAD)-based template cost, the first derived LIC flag will be true and the second signalled flag is true. In this case, LIC will be used for the current CU.

For another example, if SAD-based template cost>a Mean Removal SAD (MRSAD)-based template cost, the first derived LIC flag will be true and the second signalled flag is false. In this case, LIC will not be used for the current CU.

In one embodiment, the second flag is coded by context coded bin.

In one embodiment, the second flag is coded by more than one context variable. The selection of the context variable is dependent on the on-off of LIC of neighbouring blocks. For example, the top CU and the left CU are referenced.

In one embodiment, the second flag is coded by more than one context variables. The selection of the context variable is dependent on the current CU coded mode. For example, the context variables for an affine mode coded CU and a non-affine mode coded CU are different. For another example, the context variables for an IBC mode coded CU and a non-IBC mode coded CU are different.

In one embodiment, the second flag is only signalled for some specific merge modes. For other merge modes, the second flags do not need to be signalled. They will always be set to true. For example, regular merge mode, and MMVD merge mode need to signal the second flag. For another example, only non-skip merge mode needs to signal the second flag.

In one embodiment, the second flag is only signalled for some specific merge modes. For some merge modes, the second flags do not need to be signalled. They will always be set to true. For other merge modes (i.e., TM merge mode), implicit methods are used to indicate the on-off of the second flags. For example, TM cost is used to indicate the on-off of the second flag. For another example, neighbouring blocks second flag on-off can be referenced to determine the second flag on-off for the current block.

### LIC for AMVP-Merge

In one embodiment, a LIC flag is signalled when AMVP-Merge mode is applied.

In one embodiment, a second LIC flag is signalled when AMVP-Merge mode is applied. In that, the second LIC flag is used to indicate LIC is applied or not. In that, if LIC is applied, and the LIC flag from the corresponding merge candidate is true, the second LIC flag will be set to true. Otherwise, if LIC is applied, and the LIC flag from the corresponding merge candidate is false, the second LIC flag will be set to false.

In one embodiment, the second LIC flag is coded by context coded bins.

In one embodiment, the second LIC flag is coded by more than one context variables. The selection of the context variable is depended on the on-off of LIC of neighbouring blocks. For example, the top CU and the left CU are referenced.

In one embodiment, in AMVP-Merge mode, no LIC flag needs to be signalled. LIC will be always disabled.

In one embodiment, in AMVP-Merge mode, during reordering of merge candidate list, BM costs associated with candidates will be calculated and compared. All merge candidates in merge candidate list will be treated as LIC-off candidates during reordering.

In one embodiment, in AMVP-Merge mode, the LIC parameters of the corresponding merge candidates can be used to guide the LIC parameter derivation of the current CU. The LIC parameters of the current CU are derived based on templates of the current block and templates of the reference block. For example, a regularization term is added during the derivation of LIC parameters of the current CU. The regularization term is designed based on the LIC parameters and a lambda value of the corresponding merge candidates. The lambda value is used to control the strength of the guidance.

In one embodiment, in AMVP-Merge mode, the LIC parameters of the corresponding merge candidates can be used for the current CU. In this case, LIC parameters of the current CU do not need to be derived again.

### Inheriting LIC Information

In one embodiment, all or part of the LIC information of inherited LIC model can be stored together with the inherited LIC model parameters.

The LIC information includes, but not limited to, template region selection type (e.g., LIC_T, LIC_L or LIC_LT), size of template region, LIC model type (e.g., linear model ax+b, LIC with location term, or multiple-tap LIC), multi-model flag, classification method for multi-model, threshold for multi-model, or model parameters.

In another embodiment, after decoding a block, the LIC information of the current block is derived and stored for later reconstruction process of neighbouring blocks using inheriting neighbours model parameter. For example, even the current block is coded by non-LIC prediction, the LIC model parameters of the current block are still derived by using the reconstruction samples from the current block and reference region (e.g., identified by the current block size and motion vector). Later, if another block is predicted by using inheriting LIC model parameters of neighbouring blocks, the LIC model parameters can be inherited from the stored LIC information of the current block. For another example, even the current block is coded by LIC prediction, the LIC model parameters of the current block are re-derived by using the reconstruction samples of the current block and the reference region. For another example, the stored LIC model can be LM_LA (single model LM using both above and left neighbouring samples to derive model), or MMLM_LA (multi-model LM using both above and left neighbouring samples to derive model). For another example, the re-derived LIC model parameters can be combined with the original LIC models, which are used in reconstructing the current block. For combining with the original LIC models, assume the original LIC model parameters are

$$\{ {c}_{0}^{0} , {c}_{1}^{0} , … , {c}_{M - 1}^{0} \} ,$$

and the re-derived LIC model parameters are

$$\{ {c}_{0}^{1} , {c}_{1}^{1} , … , {c}_{M - 1}^{1} \} ,$$

the final LIC model can be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived by neighbouring template cost.

In still another embodiment, the model type of “the LIC model derived using the neighbouring samples of the current and reference blocks” and “the LIC model derived using the reconstruction samples from the current and reference blocks” are different. For example, the model types of “the LIC model derived using the neighbouring samples of the current and reference blocks” and “the LIC model derived using the neighbouring samples of the current and reference blocks” are single-model LM and multiple-model LM, or multiple-model LM and single-model LM. For another example, the model types of “the LIC model derived using the neighbouring samples of the current and reference blocks” and “the LIC model derived using the neighbouring samples of the current and reference blocks” are 2-parameter LM model (e.g., model parameters are composed of a scaling parameter and an offset parameter) and convolutional LM model (e.g., CCCM, GL-CCCM, NS-CCCM, MDF-CCCM), or convolutional LM model and 2-parameter LM model.

### Construct Inherited LIC Candidate List

In one embodiment, the candidate list is constructed by adding candidates in a pre-defined order until the maximum candidate number is reached. The candidates added can include all or some of the aforementioned candidates, but not limited to, the aforementioned candidates. For example, the candidate list can include spatial neighbouring candidates, temporal neighbouring candidate, historical candidates, non-adjacent neighbouring candidates, single model candidates generated based on other inherited models. For another example, the candidate list could include the same candidates as previous example, but the candidates are added into the list in a different order.

The candidates in the list can be reordered to reduce the syntax overhead when signalling the selected candidate index. The reordering rules can depend on the coding information of neighbouring blocks or the model error. For example, if neighbouring above or left blocks are coded by LIC and using a target cross-component prediction mode, the candidates in the lists have the target cross-component prediction mode can be moved to the head of the current list.

In still another embodiment, the reordering rule is based on the model error by applying the candidate model to the neighbouring templates of the current block, and then compare the error with the reconstruction samples of the neighbouring template. For example, as shown in FIG. 11, the size of above neighbouring template 1120 of the current block 1110 is wₐ×hₐ, and the size of left neighbouring template 1130 of the current block 1110 is w_{b}×h_{b}. Suppose K models are in the current candidate list, and αₖ and βₖ are the final scale and offset parameters after inheriting the candidate k. The model error of candidate k by the above neighbouring template is:

$${e}_{a}^{k} = {\sum }_{i , j} \vert ( {α}_{k} \times r e c {L}_{a}^{′ ( i , j )} + {β}_{k} ) - r e c {L}_{a}^{( i , j )} \vert$$

where,

$$r e c {L}_{a}^{′ ( i , j )} and {recL}_{a}^{( i , j )}$$

are the corresponding referenced luma samples of the previous coded frame and the reconstructed luma samples of the current frame at position (i, j) in the above template, and 0≤i<wₐ and 0≤j<hₐ.

Similarly, the model error of candidate k by the left neighbouring template is:

$${e}_{b}^{k} = {\sum }_{m , n} \vert ( {α}_{k} \times r e c {L}_{b}^{′ ( m , n )} + {β}_{k} ) - r e c {L}_{b}^{( m , n )} \vert$$

where

$$r e c {L}_{b}^{′ ( m , n )} and {recL}_{b}^{( m , n )}$$

are the corresponding referenced luma samples of the previous coded frame and the reconstructed luma samples of the current frame at position (m, n) in the left template, and 0≤m<wp and 0≤n<hp.

In still another embodiment, the model error of each candidate in the list can be further adjusted by the corresponding weighting factors. The weighting factors can be set according to the characteristic of the candidates in the list, such as model type (e.g., CCCM, GL-CCCM, NS-CCCM, MDF-CCCM), single model or multiple models, spatial/temporal/history/default candidate types, or the spatial geometric distance or temporal POC distance between the inherited candidate position and the current block. For example, assume the model type of “the LIC model derived using the neighbouring samples of the current and reference blocks” and “the LIC model derived using the reconstruction samples from the current and reference blocks” are X and Y, and X is not equal to Y. For one example, the weighting factor of a candidate in the list with model type X has different weighting factor of another candidate in the list with model type Y. In one embodiment, the candidate in the list with model type X has greater weighting factor than another candidate in the list with model type Y. In one embodiment, the candidate in the list with model type X has a smaller weighting factor than another candidate in the list with model type Y.

Any of the foregoing proposed methods can be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

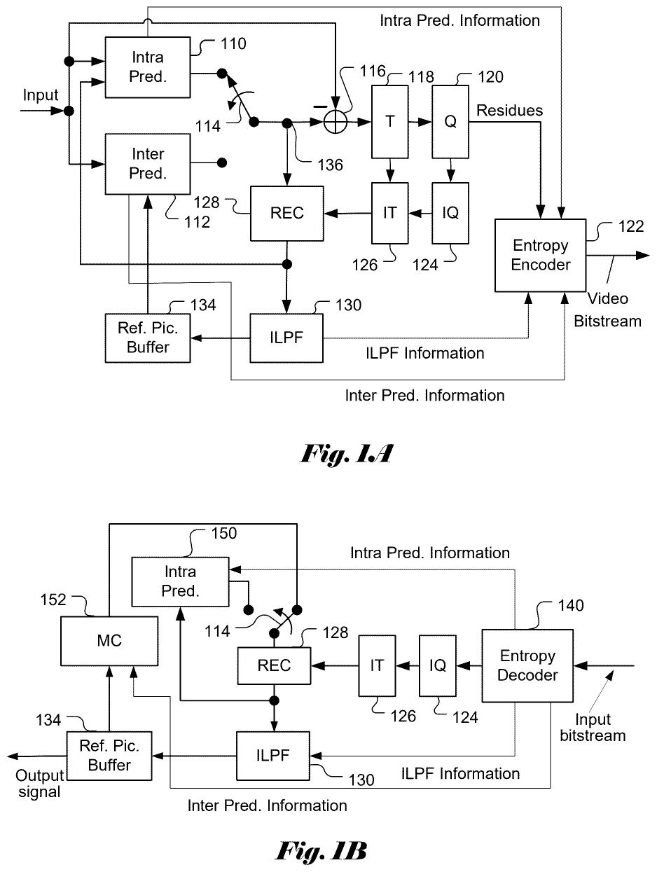

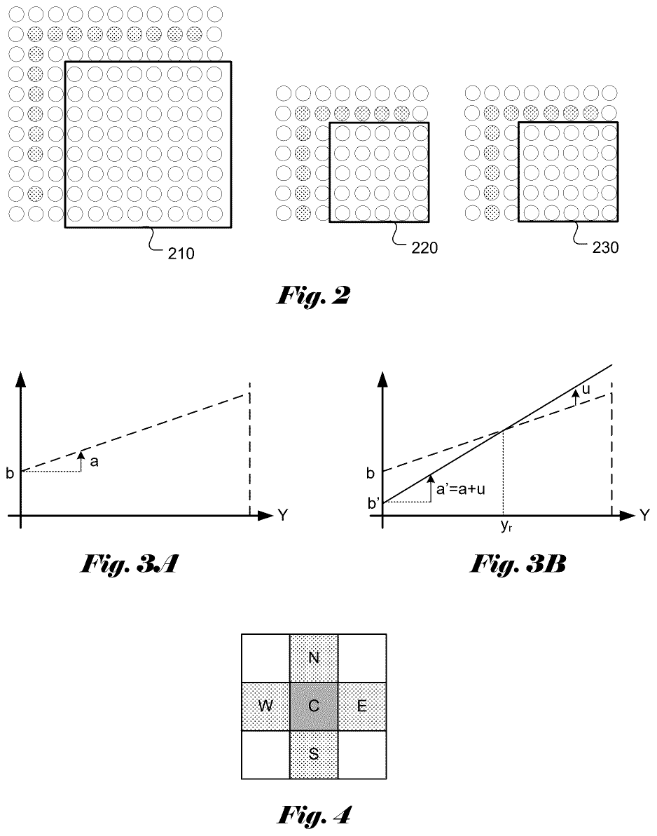

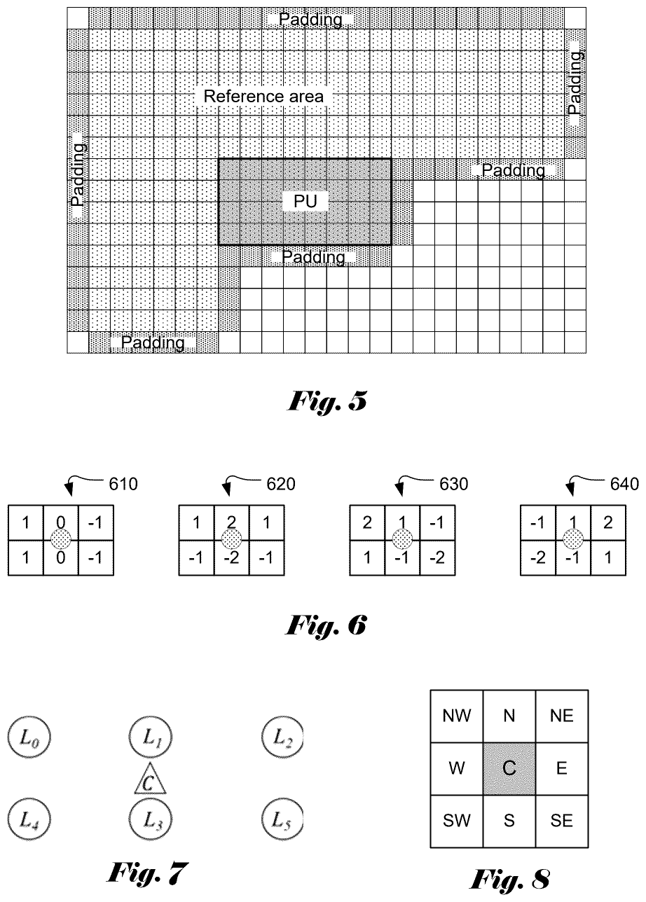

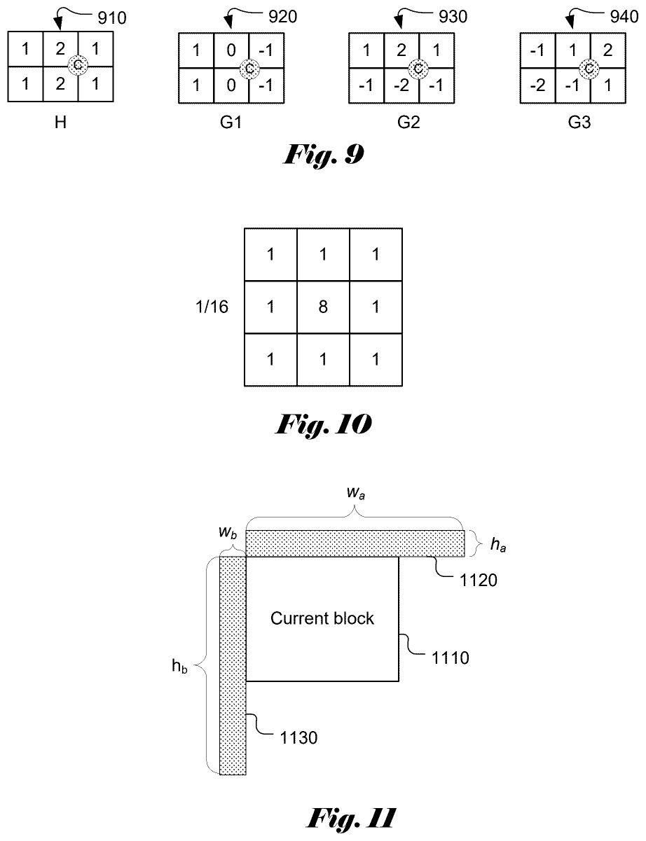

The LIC signalling as described above can be implemented in an encoder side or a decoder side. For example, any of the proposed method can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed LIC signalling can also be implemented as a circuit coupled to the intra/inter coding module at the decoder or the encoder. However, the decoder or encoder may also use additional processing unit to implement the required cross-component prediction processing. While the Intra Pred./MC units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

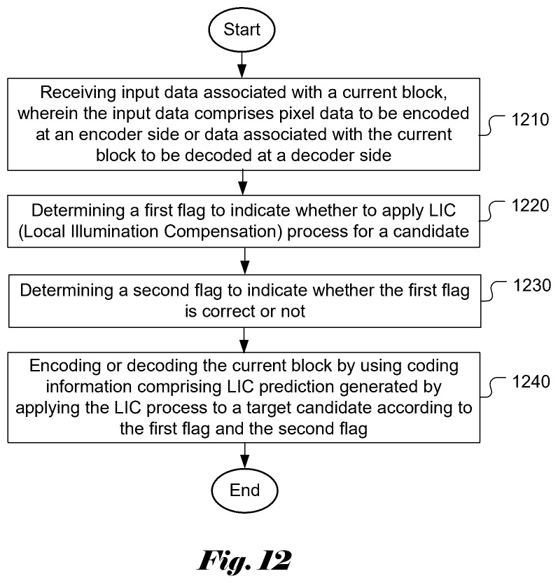

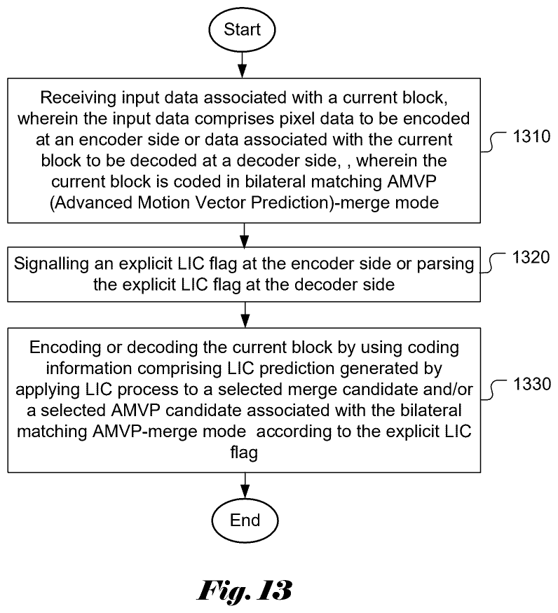

FIG. 12 illustrates a flowchart of an exemplary video coding system that uses a second LIC flag to indicate whether to use the first LIC flag according to an embodiment of the present invention. The steps shown in the flowchart may be implemented as program codes executable on one or more processors (e.g., one or more CPUs) at the encoder or decoder side. The steps shown in the flowchart may also be implemented based hardware such as one or more electronic devices or processors arranged to perform the steps in the flowchart. According to this method, input data associated with a current block is received in step 1210, wherein the input data comprises pixel data to be encoded at an encoder side or data associated with the current block to be decoded at a decoder side. A first flag to indicate whether to apply LIC (Local Illumination Compensation) process for a candidate is determined in step 1220. A second flag to indicate whether the first flag is correct or not is determined in step 1230. The current block is encoded or decoded by using coding information comprising LIC prediction generated by applying the LIC process to a target candidate according to the first flag and the second flag in step 1240.

FIG. 13 illustrates a flowchart of an exemplary video coding system that uses an explicit LIC flag to indicate whether to apply the LIC process for an AMVP-merge coded block according to an embodiment of the present invention. According to this method, input data associated with a current block is received in step 1310, wherein the input data comprises pixel data to be encoded at an encoder side or data associated with the current block to be decoded at a decoder side, wherein the current block is coded in bilateral matching AMVP (Advanced Motion Vector Prediction)-merge mode. An explicit LIC (Local Illumination Compensation) flag is signalled at the encoder side or parsed at the decoder side in step 1320. The current block is encoded or decoded by using coding information comprising LIC prediction generated by applying LIC process to a selected merge candidate and/or a selected AMVP candidate associated with the bilateral matching AMVP-merge mode according to the explicit LIC flag in step 1330.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side;
determining a first flag to indicate whether to apply LIC (Local Illumination Compensation) process for a candidate;
determining a second flag to indicate whether the first flag is correct or not; and
encoding or decoding the current block by using coding information comprising LIC prediction generated by applying the LIC process to a target candidate according to the first flag and the second flag.

2. The method of claim 1, wherein when the second flag is true, the LIC process is applied if the first flag is true and the LIC process is not applied if the first flag is false.

3. The method of claim 1, wherein when the second flag is false, the LIC process is not applied if the first flag is true and the LIC process is applied if the first flag is false.

4. The method of claim 1, wherein the second flag is coded by one or more context coded bins.

5. The method of claim 4, wherein the second flag is coded by using one or more context variables.

6. The method of claim 5, wherein selection of said one or more context variables is dependent on whether the LIC process is on or off for one or more neighbouring blocks.

7. An apparatus for video coding, the apparatus comprising one or more electronics or processors arranged to:
receive input data associated with a current block, wherein the input data comprises pixel data to be encoded at an encoder side or data associated with the current block to be decoded at a decoder side;
determine a first flag to indicate whether to apply LIC (Local Illumination Compensation) process for a candidate;
determine a second flag to indicate whether the first flag is correct or not; and
encode or decode the current block by using coding information comprising LIC prediction generated by applying the LIC process to a target candidate according to the first flag and the second flag.

8. A method of video coding, the method comprising:
receiving input data associated with a current block, wherein the input data comprises pixel data to be encoded at an encoder side or data associated with the current block to be decoded at a decoder side, wherein the current block is coded in a bilateral matching AMVP (Advanced Motion Vector Prediction)-merge mode;
signalling an explicit LIC (Local Illumination Compensation) flag at the encoder side or parsing the explicit LIC flag at the decoder side; and
encoding or decoding the current block by using coding information comprising LIC prediction generated by applying LIC process to a selected merge candidate and/or a selected AMVP candidate associated with the bilateral matching AMVP-merge mode according to the explicit LIC flag.

9. The method of claim 8, wherein when an inherited LIC flag from a selected merge candidate is true, the LIC process is applied if the explicit LIC flag is set to true and the LIC process is not applied if the explicit LIC flag is set to false.

10. The method of claim 8, wherein when an inherited LIC flag from a selected merge candidate is false, the LIC process is applied if the explicit LIC flag is set to false and the LIC process is not applied if the explicit LIC flag is set to true.

11. The method of claim 8, wherein the explicit LIC flag is coded by one or more context coded bins.

12. The method of claim 8, wherein the explicit LIC flag is coded by using one or more context variables.

13. The method of claim 12, wherein selection of said one or more context variables is dependent on whether the LIC process is on or off for one or more neighbouring blocks.

14. An apparatus for video coding, the apparatus comprising one or more electronics or processors arranged to:
receive input data associated with a current block, wherein the input data comprises pixel data to be encoded at an encoder side or data associated with the current block to be decoded at a decoder side, and wherein the current block is coded in bilateral matching AMVP (Advanced Motion Vector Prediction)-merge mode;
signal an explicit LIC (Local Illumination Compensation) flag at the encoder side or parse the explicit LIC flag at the decoder side; and
encode or decode the current block by using coding information comprising LIC prediction generated by applying LIC process to a selected merge candidate and/or a selected AMVP candidate according to the explicit LIC flag.
